(19) United States
(12) Patent Application Publication
(10) Pub. No.: US 2004/0189488 A1
(43) Pub. Date: Sep. 30, 2004

(54) System and method for metering electricity supplied to a customer

(75) Inventors: Paul Elliott, Brooklin (CA); Frank Conte, Niagara Falls (CA)

Correspondence Address: BERESKIN AND PARR, SCOTIA PLAZA, 40 KING STREET WEST-SUITE 4000 BOX 401, TORONTO, ON, M5H 3Y2, CA

(73) Assignees: WHITBY HYDRO ENERGY SERVICES CORPORATION, Whitby (CA); TMR METERING INC., Vaughan (CA)

(21) Appl. No.: 10/395,247

(22) Filed: Mar. 25, 2003

(51) Int. Cl. G08C 15/06; G08B 23/00

(52) U.S. Cl. 340/870.02

(57) ABSTRACT

A system and method for metering electricity supplied to a customer is described. The system includes a source of electricity at a primary voltage, and a transformer unit for decreasing the primary voltage of the electricity before supplying the electricity at a decreased voltage to the customer. The system also includes a metering apparatus for metering the electricity supplied to the customer. The metering apparatus includes a metering control unit that is near the transformer unit.

### FIELD OF THE INVENTION

The invention relates to metering electricity supplied to a customer.

### BACKGROUND OF THE INVENTION

Utility companies provide electricity to many customers in both rural and urban settings. The electricity provided is generated at a generating plant, and transmitted via transmission lines that span large geographic areas. To minimize power loss associated with the internal resistance of the transmission lines, so-called ohmic loss, the voltage of the electricity is typically increased or “stepped-up” near the generating plant before being transmitted via the transmission lines. Transmission line voltages can vary from 600V to 500,000V, with a typical voltage near a residential site being about 4,000V to 8,000V. Before being delivered to the customer, this high, potentially dangerous voltage is decreased or “stepped-down” with a step-down transformer.

Besides the delivery of electricity, an important component of the utility company involves accurately metering the amount of electrical energy supplied to a consumer to later bill them therefor. The meter for this purpose is located near the customer. For residential customers, the meter is typically adjacent to an outside wall of the house of the customer to which electricity is supplied. Unfortunately, the fact that the meter is located on the premises of the customer, allows unscrupulous customers to tamper with the meter. For example, by boring a hole in the ground to access a frost loop, which is a coil of conductor for accommodating weather extremes, the customer can bypass the meter and avoid being charged for electricity use. This problem is widespread enough to cause large monetary losses for utility companies.

It is an object of the present invention to mitigate the problem of meter tampering.

### SUMMARY OF THE INVENTION

In accordance with the present invention, a system and method are provided for metering the electricity supplied to a customer that circumvent the aforementioned problems associated with losses that arise because of meter tampering. The meter is disposed near the step-down transformer where it cannot be by-passed by the customer. For example, the meter can be affixed to a surface of the transformer unit. The utility has secure means to prevent access to the transformer.

In particular, a system is described herein for metering electricity supplied to a customer. The system includes a source of electricity at a primary voltage, and a transformer unit for decreasing the primary voltage of the electricity before supplying the electricity at a decreased voltage to the customer. The system further includes a metering apparatus for metering the electricity supplied to the customer. The metering apparatus contains a metering control unit that includes at least one of a) a processor for determining an amount of electrical energy supplied to the customer, b) a datalogger for storing data that is indicative of the amount of electrical energy supplied to the customer, c) a display for displaying the amount of electrical energy supplied to the customer, and d) a communication link for transmitting the data to a remote site. The metering control unit is disposed near the transformer unit. In particular, the distance from the metering control unit to the transformer unit is less than forty-two centimeters.

Such a distance affords various installation options. In particular, forty-two centimeters is long enough to permit other hardware, such as wiring, to be installed between the transformer unit and the metering control device. This distance is also short enough to be able to use some of the existing components at the transformer site for metering, such as the concrete support of the transformer unit to affix the metering control unit, or a locked enclosure to restrict access to the metering control unit.

### BRIEF DESCRIPTION OF THE DRAWINGS

FIG. 1 shows a block diagram of a transformer-metering system for metering electricity supplied to a customer, according to the teachings of the present invention.

FIG. 2 shows the transformer unit of the transformer-metering system of FIG. 1.

FIG. 3 shows the metering apparatus of the transformer-metering system of FIG. 1.

FIG. 4 shows a profile of the transformer-metering system of FIG. 1.

FIG. 5 shows a line diagram of the transformer-metering system of FIG. 1.

FIG. 6 is a flowchart for metering electricity supplied to a customer, according to the teachings of the present invention.

### DETAILED DESCRIPTION OF THE INVENTION

The electricity provided by utility companies is generated at a generating plant, and transmitted via transmission lines that span large geographic areas. To minimize power loss associated with the internal resistance of the transmission lines, so-called ohmic loss, the voltage of the electricity is typically increased or “stepped-up” near the generating plant before being transmitted via the transmission lines. A typical transmission voltage at the residential level can be about about 8000V. Before being delivered to the customer, this high, potentially dangerous voltage is decreased or “stepped-down” with a step-down transformer. The stepped-down voltage that is delivered to a customer is metered to determine the cost to be incurred by the customer.

In accordance with the present invention, the metering apparatus is installed near the transformer, which prevents the customer from tampering with the meter. Installing the meter near the transformer also saves costs by avoiding duplication of hardware. For example, the transformer site usually already includes supports that can be used to install the meter, as well as security components, such as padlocks to restrict access to authorized personnel. Additionally, installing the meter near a high-voltage transformer can act as a deterrent to someone thinking of breaching the enclosure containing the transformer and meter.

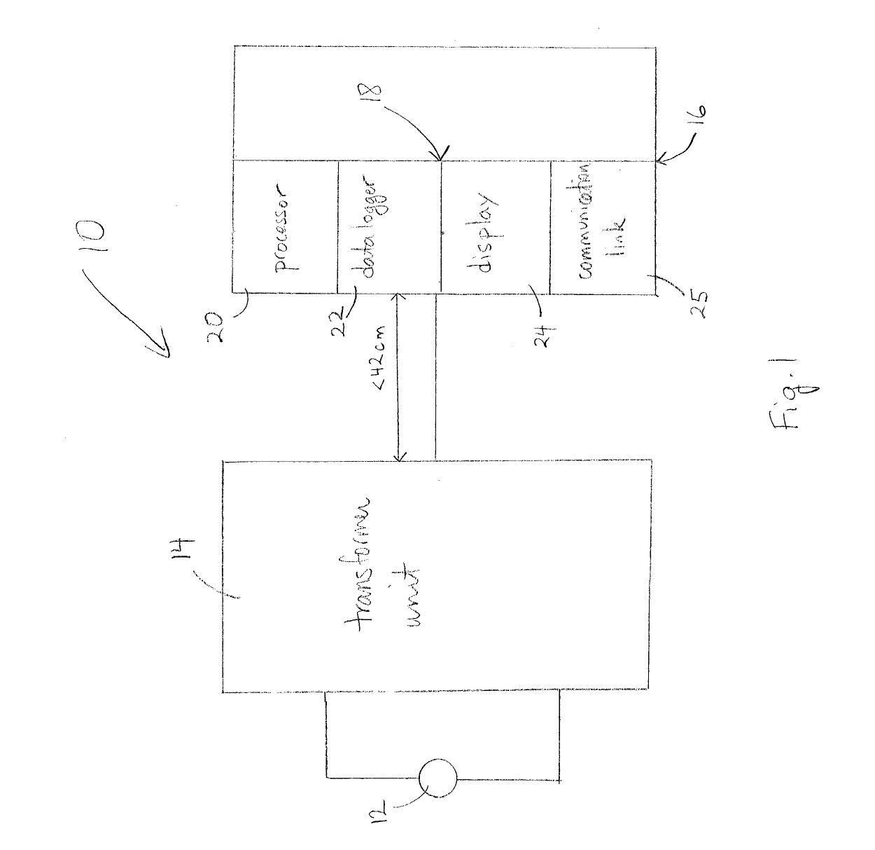

FIG. 1 shows a block diagram of a transformer-metering system 10 for metering electricity supplied to a customer, according to the teachings of the present invention. The transformer-metering system 10 includes a source of electricity 12 at a primary voltage, a transformer unit 14, and a metering apparatus 16 that contains a metering control unit 18. The metering control unit 18 includes at least one of a processor 20, a datalogger 22, a display 24 and a communication link 25. The distance from the metering control unit 18 to the transformer unit 14 is less than forty-two centimeters.

The source of electricity 12 can be a conductor connected to a transmission line used to transmit electricity from a generating site, as known to those of ordinary skill. The primary voltage at which electricity is transmitted is typically large, e.g., 4000V-27,600V, to minimize ohmic losses. Before the electricity is provided to the customer, the primary voltage is reduced. The transformer unit 14 decreases the primary voltage of the electricity before supplying the electricity at a decreased voltage to the customer.

The metering apparatus 16 meters the electricity supplied to the customer with the metering control unit 18. The metering control unit 18 includes at least one of a processor 20 for determining an amount of electrical energy supplied to the customer, a datalogger 22 for storing data that is indicative of the amount of electrical energy supplied to the customer; a display 24 for displaying the amount of electrical energy supplied to the customer, and a communication link 25 for transmitting the data, which is indicative of the amount of electrical energy supplied to the customer, to a remote site. For example, the communication link 25 can be connected to a computer network that can be accessed by the utility company to download the data. Alternatively, or in addition, the data can automatically be downloaded at predetermined intervals to the utility company via the communication link 25.

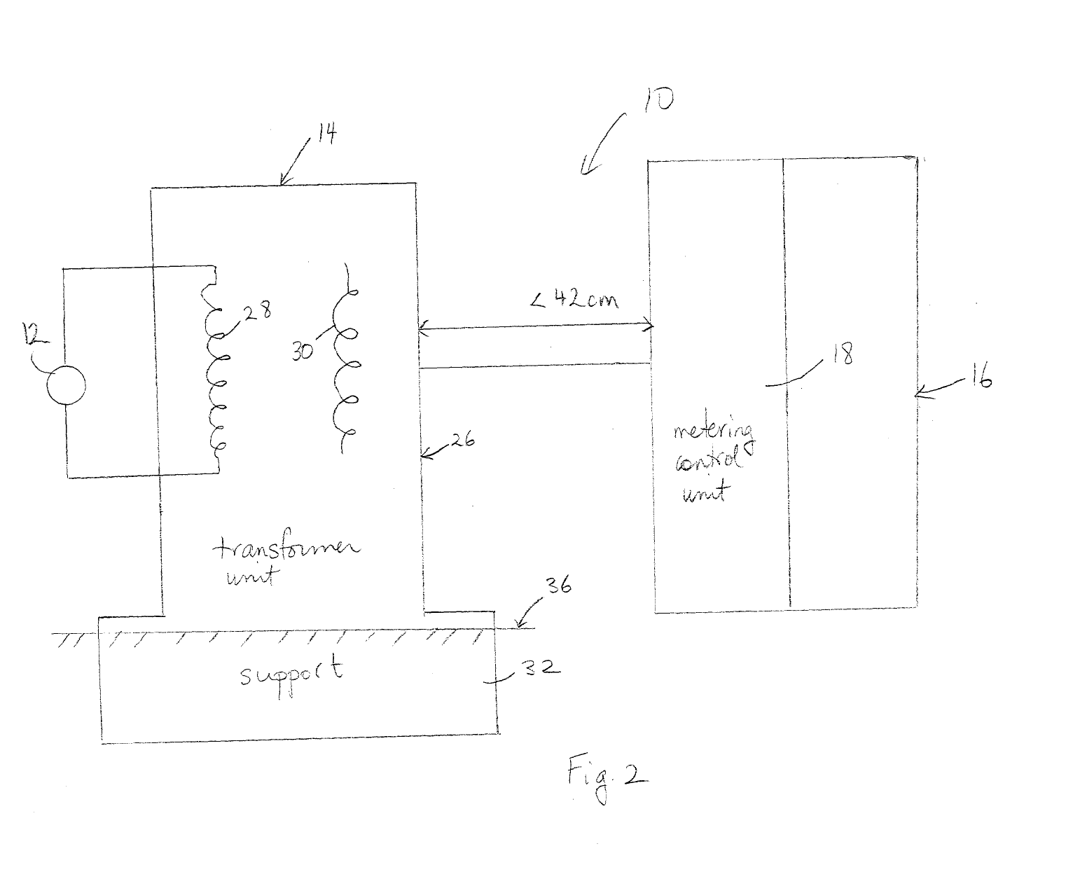

FIG. 2 shows the transformer unit 14 of the transformer-metering system 10 of FIG. 1. The transformer unit 14 includes a step-down module 26 that contains a primary coil 28 and a secondary coil 30. The transformer unit 14 also includes a support 32.

The step-down module 26 reduces or “steps-down” the primary voltage. In particular, the primary coil 28 is a conductor that is wound N_{P} times around a core, such as an iron core. Electricity at the primary voltage, in the form of an alternating current, flows through the primary coil. The second coil 30 is also a conductor that winds around the core N_{S} times, with N_{S}<N_{P}. As predicted by Faraday's Law of Induction, a voltage is induced in the secondary coil, which is less than the primary voltage because N_{S}<N_{P}. The induced voltage results in an alternating current in the secondary coil. Thus, electricity at the reduced voltage flows in the secondary coil before being supplied to the customer. Typically, the reduced voltage is greater than or equal to about 120V and less than or equal to about 240 V.

The transformer unit 14 includes a support 32 for supporting the step-down module 26. For example, the support 32 can include a concrete vault that is partially buried below ground level 36. Alternatively, the support 32 can be of a pedestal type; the support 32 can also be constructed from fiberglass or plastic. In one embodiment, the metering control unit 18 is affixed to the support with bolts. Alternatively, the metering control unit 18 can be affixed to the transformer unit 14 at a different location, such as the outer surface of the step-down module 26.

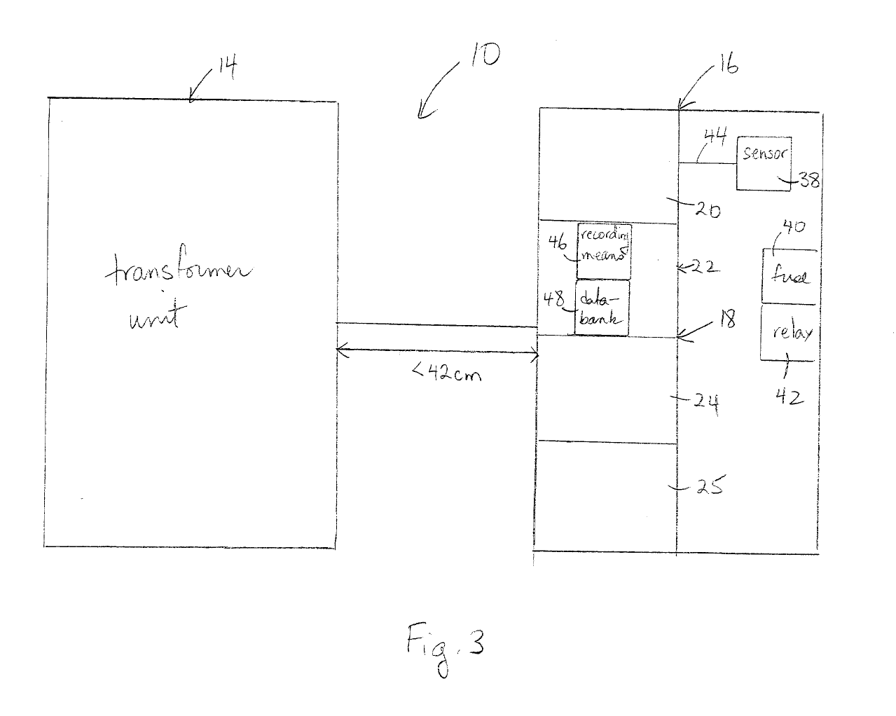

FIG. 3 shows the metering apparatus 16 of the transformer-metering system 10 of FIG. 1. The metering apparatus 16 includes a sensor 38, and, as described above, a metering control unit 18 that includes at least one of a processor 20, a datalogger 22, a display 24 and a communication link 25. The metering control unit 18 may further include a potential fuse 40 and a relay 42. The sensor 38 is connected to the metering control unit 18, by a metering conductor 44.

The sensor 38 produces an electrical signal for determining the amount of electrical energy supplied to the customer. The sensor 38, for example, can include at least one of a current transformer, a potential transformer and a watt transformer. The electrical signal is transmitted to the metering control unit 18 via the metering conductor 44. Once the signal reaches the metering control unit 18, the processor 20 therein can determine the amount of electrical energy supplied to the customer.

The datalogger 22, which has recording means 46 to write or delete data, and/or a databank 48, stores data indicative of the amount of electrical energy supplied to the customer. The display 24 can display this amount so that it may be read by power personnel and/or the customer. The communication link 25 can be used to transmit the data to a remote site. For example, the communication link 25 can be connected to a computer network that can be accessed by the utility company to download the data. Alternatively, or in addition, the data can automatically be downloaded at predetermined intervals to a server of the utility company via the communication link 25. Optionally, the server can be accessed by the customer, provided the customer has a password that allows access to the data.

The potential fuse 40 protects the metering apparatus 16 from a short circuit or overload, and the relay 42 is used to remotely switch a particular load on and off. For example, the relay can include an electrical switch that is remotely controlled by the injection of a coded signal into the electrical network. For example, the relay 42 can permit the utility company to switch water heating on and off at set times.

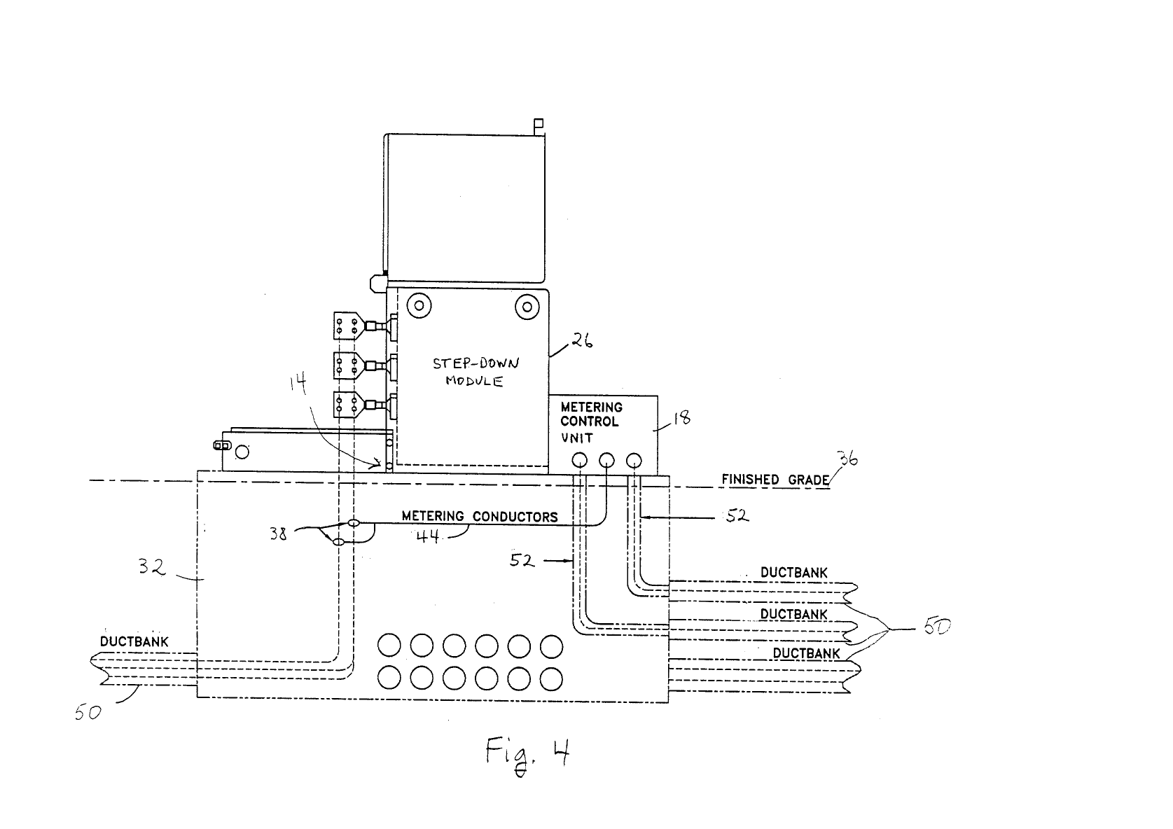

FIG. 4 shows a profile of the transformer-metering system 10 of FIG. 1. The transformer-metering system 10 includes the step-down module 26, the metering control unit 18, the sensors 38 and the metering conductors 44. The transformer-metering system 10 also includes duct banks 50 and internal conduits 52.

The duct banks 50 and internal conduits 52 serve as pathways for inserting wiring necessary to carry the electricity to various customers and to link the transformer site to the phone company. Such a link allows meter data to be accessed using telephone lines. The metering control unit 18 is disposed in the area where the support 32 (e.g., a concrete vault) and the step-down module 26 meet, and can be bolted to either or both. By placing the metering control unit 18 near the transformer unit 14, instead of near the residence of the customer, tampering with the metering of electricity is more difficult. In fact, as access to the transformer unit 14 is typically restricted to only utility personnel with a locked cabinet or other enclosure, the transformer unit 14 and the metering control unit 18 are well-protected from tampering.

The sensor 38 can be a device that produces an electrical signal suitable for determining the amount of electrical energy supplied to the customer. For example, a current, potential or watt AC transformer (or transducer) running at an amperage of 0-5 A and voltage of 120-240V, and accepting a variety of AC waveform inputs can be used. These transformers typically have an accuracy of better than 2% for watt transducers and 1% for potential and current transducers, and a current output capable of supplying up to 10 or 20 mA in low-impedance metering. These transformers can have their own built-in power supplies that operate on either 120 VAC or 240 VAC.

The signal from the sensor 38 is processed by the processor 20 of the metering control unit 18. The processor 20 can employ various types of metering, such as time-of-use metering and static metering. In time-of-use metering, electrical energy that is measured is recorded discreetly by the datalogger 22 for an interval of time, such as each minute. The intervals are stored electronically along with the date and time of energy usage. These are retrieved electronically via the communication link 25 at a later date.

In static metering, the energy that is measured is recorded on a cumulative register display 24, or a digital LCD display 24, in contrast to time-of-use metering, where the energy is recorded and the meter zeroed periodically, such as every minute. Static metering may be done with single displays, such that any energy consumed on a site is shown on the display. The display 24 allows a customer to physically see the meter read. To take a reading for a particular month off of the static meter, the previous months read is subtracted from the current read.

Metering data on the dataloggers can be accessed by one of several methods, such as telephone (including cell phone), landline and visually. Metering data can be downloaded via a cell phone. The landline may be a telephone line, a computer network line or a fibre optic line, such as links the Internet.

The metering data can be downloaded to a utility company server via the communication link 25, which may then be accessed by the customer using a computer network or telephone line. The metering data may also be read visually from the display 24. In particular, a customer can arrange to read the display 24 at the site of the transformer unit 14 with the assistance of utility personnel.

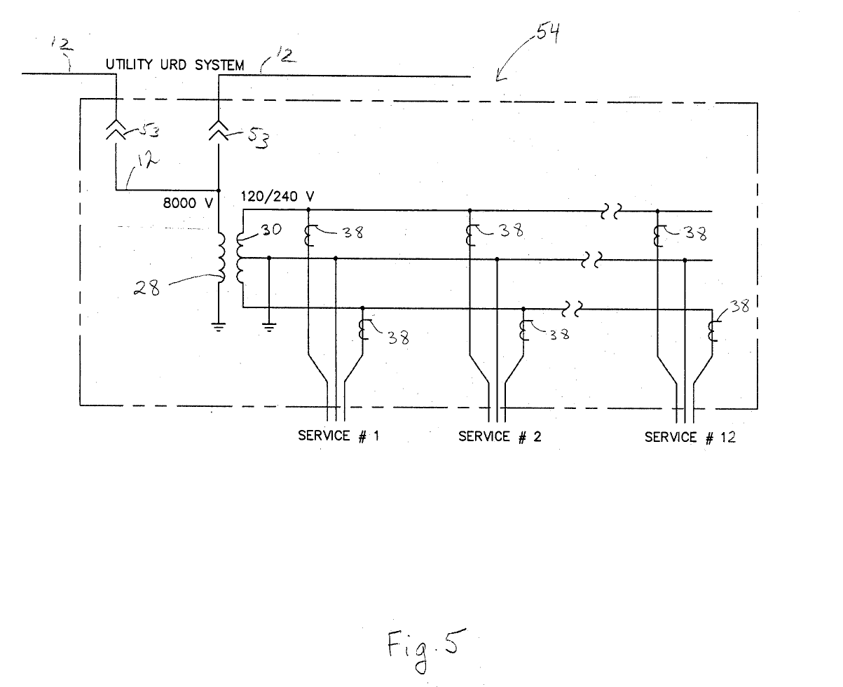

FIG. 5 shows a line diagram 54 for the transformer-metering system 10 of FIG. 1. Electricity at the primary voltage 12 can arrive at the primary coil 28 via a utility underground system. Elbows 53 allow a proper connection between the source 12 and the primary coil 28. The voltage at the primary coil is typically 8000V. The primary coil 28 induces a current in the secondary coil 30 of reduced voltage. With the one step-down module 26 containing the coils 28 and 30, at least twelve houses or residential customers (service numbers 1-12) can be served. In some cases, twenty to thirty customers can be served. The current transformer sensors 38 can produce an electrical signal that can be used by the processor 20 to meter the electricity supplied to the homes.

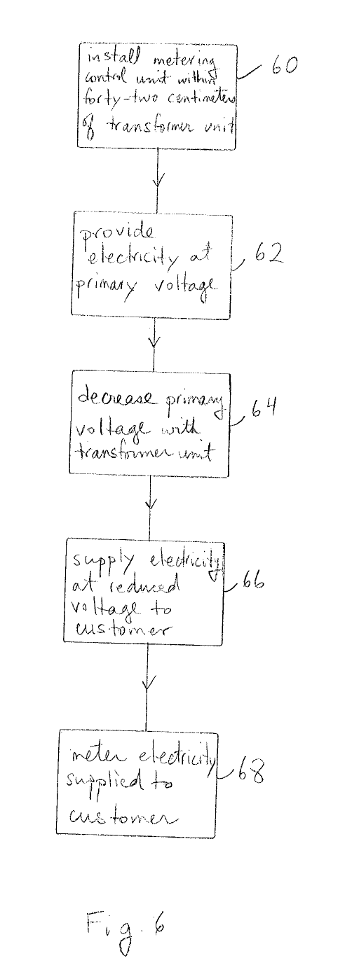

FIG. 6 is a flowchart for metering electricity supplied to a customer. In step 60, the metering control unit 18 is installed within forty-two centimeters of the transformer unit 14. In step 62, electricity is provided at the primary voltage. In step 64, the primary voltage of the electricity is decreased with the transformer unit 14. In step 66, electricity is supplied at a decreased voltage to the customer, and, in step 68, metered with the metering control apparatus 18.

It should be understood that various modifications and adaptations could be made to the embodiments described and illustrated herein, without departing from the present invention. For example, although emphasis has been placed on describing a transformer-metering system 10 having a metering control unit 18 affixed to the support 32, it is possible to dispose the system anywhere within forty-two centimeters of the transformer unit 14. The scope of the invention is defined by the following claims.

1. A system for metering electricity supplied to a customer, the system comprising
a source of electricity at a primary voltage;
a transformer unit for decreasing the primary voltage of the electricity before supplying the electricity at a decreased voltage to the customer; and
a metering apparatus for metering the electricity supplied to the customer, the metering apparatus containing a metering control unit that includes at least one of
a processor for determining an amount of electrical energy supplied to the customer;
a datalogger for storing data that is indicative of the amount of electrical energy supplied to the customer;
a display for displaying the amount of electrical energy supplied to the customer; and
a communication link for transmitting the data to a remote site, wherein the distance from the metering control unit to the transformer unit is less than forty-two centimeters.

2. The system of claim 1, wherein the primary voltage is between about 4000V and about 27,600 V.

3. The system of claim 1, wherein the transformer unit contains a step-down module that includes
a primary coil through which the electricity at the primary voltage flows; and
a secondary coil through which the electricity at the reduced voltage flows before being supplied to the customer.

4. The system of claim 1, wherein the transformer unit includes a support for supporting the step-down module.

5. The system of claim 4, wherein the support includes a concrete vault.

6. The system of claim 5, wherein the concrete vault is partially buried below ground level.

7. The system of claim 4, wherein the metering control unit is affixed to the support.

8. The system of claim 1, wherein the reduced voltage is greater than or equal to about 120V and less than or equal to about 240 V.

9. The system of claim 1, wherein the metering apparatus includes a sensor to produce an electrical signal for determining the amount of electrical energy used by the customer.

10. The system of claim 9, wherein the sensor includes at least one of a current transformer, a potential transformer and a watt transformer.

11. The system of claim 10, wherein the sensor is connected to the metering control unit by a metering conductor.

12. The system of claim 10, wherein the metering apparatus further includes a potential fuse for protecting the metering apparatus from a short circuit or overload.

13. The system of claim 1, wherein the metering control unit includes
a datalogger for storing data indicative of the amount of electrical energy used by the customer; and
a display for displaying the amount of electrical energy supplied to the customer.

14. The system of claim 13, wherein the datalogger includes
recording means for recording the data; and
a databank for saving the data.

15. The system of claim 1, wherein the transformer unit has a surface on which the metering control unit is affixed.

16. The system of claim 1, further comprising a security barrier to restrict access to the system.

17. The system of claim 16, wherein the security barrier includes a fence or locked cabinet.

18. A method for metering electricity supplied to a customer, the method comprising
providing electricity at a primary voltage;
decreasing the primary voltage of the electricity with a transformer unit;
supplying the electricity at a decreased voltage to the customer; and
metering the electricity supplied to the customer with a metering apparatus that includes a metering control unit for at least one of
determining an amount of electrical energy supplied to the customer;
storing data that is indicative of the amount of electrical energy supplied to the customer;
displaying the amount of electrical energy supplied to the customer; and
transmitting the data to a remote site, wherein the distance from the metering control unit to the transformer unit is less than forty-two centimeters.

19. The method of claim 18, wherein the primary voltage is between about 4000V and about 27,600V.

20. The method of claim 18, wherein the step of decreasing includes
providing a primary coil through which the electricity at the primary voltage flows; and
providing a secondary coil through which the electricity at the reduced voltage flows before the step of supplying to the customer.

21. The method of claim 18, further comprising supporting the step-down module with a support.

22. The method of claim 21, wherein the support includes a concrete vault.

23. The method of claim 22, wherein the concrete vault is partially buried below ground level.

24. The method of claim 21, further comprising affixing the metering control unit to the support.

25. The method of claim 18, wherein the reduced voltage is greater than or equal to about 120V and less than or equal to about 600 V.

26. The method of claim 18, wherein the step of metering includes determining the amount of electrical energy supplied to the customer with a sensor.

27. The method of claim 26, wherein the sensor includes at least one of a current transformer, a potential transformer and a watt transformer.

28. The method of claim 27, further comprising connecting the sensor to the metering control unit with a metering conductor.

29. The method of claim 18, further comprising
protecting the metering apparatus from a short circuit or overload with a potential fuse; and
remotely switching a particular load on and off with a relay.

30. The method of claim 18, further comprising
storing data indicative of the amount of electrical energy supplied to the customer with a datalogger in the metering control unit; and
displaying the amount of electrical energy supplied to the customer.

31. The method of claim 18, further comprising affixing the metering control unit to a surface of the transformer unit.

32. The method of claim 18, further comprising restricting access to the system with a security barrier.

33. The method of claim 32, wherein the security barrier includes a fence.
